(19) United States
(12) Patent Application Publication
(10) Pub. No.: US 2019/0337131 A1
(43) Pub. Date: Nov. 7, 2019

(54) Fastener Extractor and Dislodging Tool Apparatus

(71) Applicant: GRIP HOLDINGS LLC, Brandon, FL (US)

(72) Inventors: Paul Kukucka, Brandon, FL (US); Thomas Stefan Kukucka, Brandon, FL (US)

(21) Appl. No.: 16/514,117

(22) Filed: Jul. 17, 2019

Related U.S. Application Data
(63) Continuation-in-part of application No. 16/255,341, filed on Jan. 23, 2019.
Application No. 16/255,341 is a continuation-in-part of application No. 16/107,842, filed on Aug. 21, 2018.
Application No. 16/107,842 is a continuation-in-part of application No. PCT/IB2017/054379, filed on Jul. 19, 2017.
Application No. PCT/IB2017/054379 is a continuation-in-part of application No. 15/601,864, filed on May 22, 2017.
Application No. 16/107,842 is a continuation-in-part of application No. PCT/IB2017/052453, filed on Apr. 27, 2017.
(60) Provisional application No. 62/733,507, filed on Sep. 19, 2018.
(60) Provisional application No. 62/733,507, filed on Sep. 19, 2018.
(60) Provisional application No. 62/328,102, filed on Apr. 27, 2016.

(51) Int. Cl. B25B 27/18

(52) U.S. Cl. CPC B25B 27/18

(57) ABSTRACT

A fastener extractor and dislodging tool apparatus includes a torque-tool body, a threaded opening, a plurality of engagement features, and a release bolt. The plurality of engagement features that grips the lateral surface of the stripped fastener is radially positioned around a rotation axis of the torque-tool body. The plurality of engagement features being perimetrically connected around a base of the torque-tool body thus delineating a socket body that removes the stripped fastener. The threaded opening traverses through the base so that the release bolt can be threadedly engaged with the threaded opening, opposite of the plurality of engagement features. When the stripped fastener is jammed within the plurality of engagement features, the release bolt can be threadedly moved into the space between the plurality of engagement features thus dislodging the stripped fastener from the torque-tool body.

The current application is a continuation-in-part (CIP) application of a U.S. non-provisional application Ser. No. 16/255,341 filed on Jan. 23, 2019. The U.S. non-provisional application Ser. No. 16/255,341 claims a priority to a U.S. provisional application Ser. No. 62/733,507 filed on Sep. 19, 2018.

### FIELD OF THE INVENTION

The present invention generally relates to various tools designed for extracting or removing fasteners, in particular bolts and nuts. More specifically, the present invention discloses a combination of anti-slip threaded extractors that are designed to remove a damaged fastener and a dislodging tool to remove the damaged fastener from the combination of anti-slip threaded extractors.

### BACKGROUND OF THE INVENTION

Hex bolts, nuts, screws, and other similar threaded devices are used to secure and hold multiple components together by being engaged to a complimentary thread, known as a female thread. The general structure of these types of fasteners is a cylindrical shaft with an external thread and a head at one end of the shaft. The external thread engages a complimentary female thread tapped into a hole or a nut and secures the fastener in place, fastening the associated components together. The head receives an external torque force and is the means by which the fastener is turned, or driven, into the female threading. The head is shaped specifically to allow an external tool like a wrench to apply a torque to the fastener in order to rotate the fastener and engage the complimentary female threading to a certain degree. This type of fastener is simple, extremely effective, cheap, and highly popular in modern construction. One of the most common problems in using these types of fasteners, whether male or female, is the tool slipping in the head portion, or slipping on the head portion. This is generally caused by either a worn fastener or tool, corrosion, overtightening, or damage to the head portion of the fastener. Various methods may be used to remove a fastener, some more aggressive than others. Once a fastener head is damaged, a more aggressive method must be implemented to remove a seized fastener. Drilling out the fastener is a common method used by some users to dislodge the fastener. While this method can prove to be effective in some scenarios there is a high risk of damaging the internal threads of the hole.

The present invention is a fastener extractor and dislodging tool apparatus that virtually eliminates the chance of slippage. The present invention uses a series of integrated splines that bite into the head of the fastener and allow for efficient torque transfer between the extractor bit and the head portion of the fastener. The present invention also overcomes another common issue of the traditional bolt extractors, which is material from the fastener heat or the actual fastener being attached or stuck to the extractor tool. More specifically, the present invention allows users to easily dislodge any remaining material and/or the removed fastener from the extracting tool through a dislodging tool.

### BRIEF DESCRIPTION OF THE DRAWINGS

FIG. 1 is a perspective view of the present invention, showing the torque-tool body, the plurality of engagement features, and the release bolt.

FIG. 2 is a top view of the torque-tool body and the bottom surface of the attachment body of the present invention

FIG. 3 is a top view of the torque-tool body and the plurality of engagement features of the present invention, showing the section that a detailed view is taken shown in FIG. 4.

FIG. 4 is a detailed view for the plurality of engagement features of the present invention taken within section line A.

FIG. 5 is a side view of the torque-tool body of the present invention, showing the plane upon which a cross sectional view is taken shown in FIG. 6.

FIG. 6 is a cross section view of the torque-tool body of the present invention taken along line A-A of FIG. 5.

FIG. 7 is a side view of the release bolt of the present invention.

FIG. 8 is a cross sectional view of the torque-tool body, the plurality of engagement features, and the release bolt of the present invention.

FIG. 9 is a top view of the torque-tool body and the plurality of engagement features of the first alternative embodiment of the present invention, showing the section that a detailed view is taken shown in FIG. 10.

FIG. 10 is a detailed view for the plurality of engagement features of the first alternative embodiment of the present invention taken within section line A, and showing the section that a detailed view is taken shown in FIG. 11

FIG. 11 is a detailed view for the plurality of engagement features of the first alternative embodiment of the present invention taken within section line B.

FIG. 12 is a top view of the torque-tool body and the plurality of engagement features of the second alternative embodiment of the present invention.

### DETAIL DESCRIPTIONS OF THE INVENTION

All illustrations of the drawings are for the purpose of describing selected versions of the present invention and are not intended to limit the scope of the present invention.

The present invention generally related to extracting tools and extracting tool accessories. More specifically the present invention discloses a fastener extractor and dislodging tool apparatus. Removing damaged/stripped fasteners from an extractor tool can prove to be a difficult task. The present invention aims to solve this issue by disclosing a release tool that is selectively engaged into an extractor tool. The release tool specifically designed to assist users with removing any pieces of damaged/stripped fasteners which may have been wedged onto the extractor tool. Furthermore, the present invention is compatible with male-member based head designs of fasteners. Fasteners which utilize a male-member head design, also known as male fasteners, use the external lateral surface of the fastener head to engage a tool for tightening or loosening, such fasteners include hex bolts and nuts. An example of a male fastener is a bolt with a hex shaped head. In addition, the present invention is compatible with male fasteners of a right-hand thread and male fasteners of a left-hand thread.

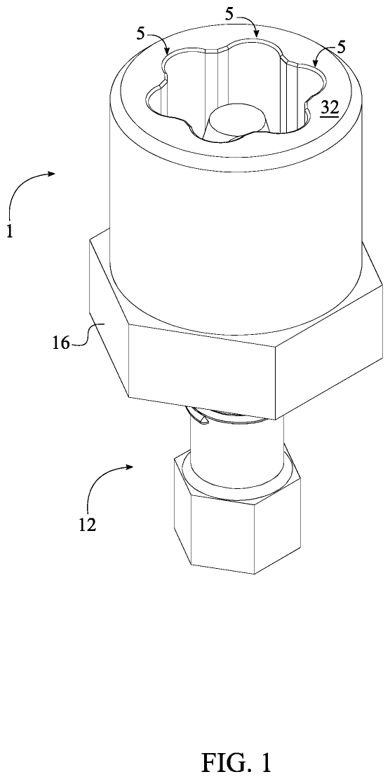

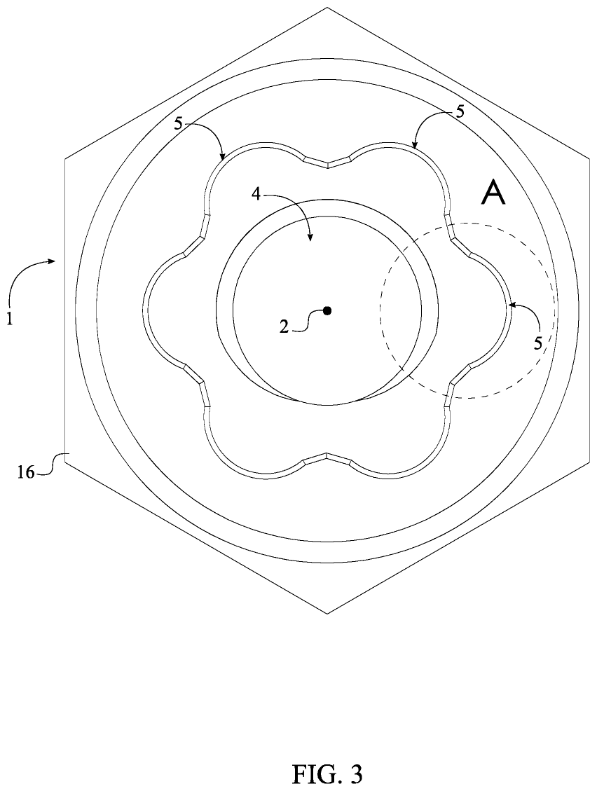

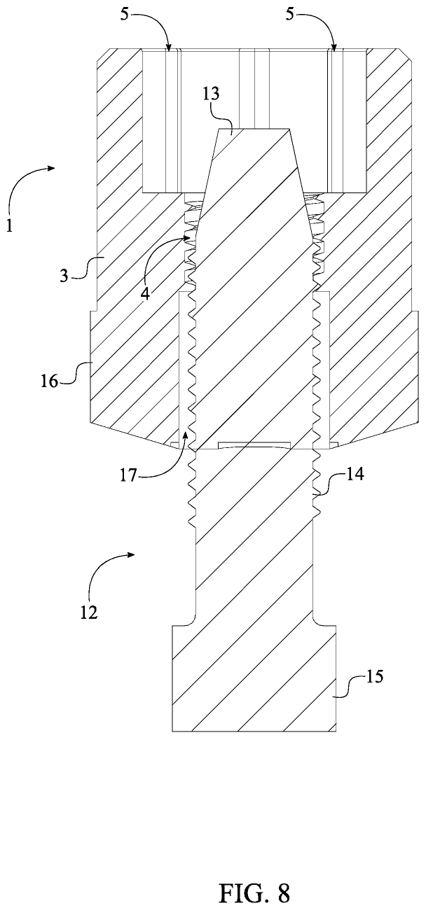

Referring to FIG. 1 and FIG. 8, the present invention comprises a torque-tool body 1, a threaded opening 4, a plurality of engagement features 5, and a release bolt 12. The torque-tool body 1 is used as the physical structure to apply the corresponding force by the plurality of engagement features 5 on the fastener head. For a male fastener, the torque-tool body 1 is a tubular extrusion sized to fit over the male fastener in an interlocking manner, similar to a wrench socket. The length, width, and diameter of the torque-tool body 1 may vary to fit different sized male fasteners. The plurality of engagement features 5 prevents slippage during fastener extraction and is radially positioned around a rotational axis 2 of the torque-tool body 1 as seen in FIG. 3. More specifically, the plurality of engagement features 5 is perimetrically connected around a base 3 of the torque-tool body 1 to grip the lateral surfaces of the fastener head. As a result, the plurality of engagement features 5 facilitates the transfer of torque to the male fastener by preventing slippage between the torque-tool body 1 and the fastener head. The threaded opening 4 traverses through the base 3 and functions as an attachment feature for the release bolt 12. More specifically, the release bolt 12 is threadedly engaged with the threaded opening 4 and positioned opposite of the plurality of engagement features 5. As a result, when the damaged/stripped fastener is jammed within the plurality of engagement features 5 after removal, the release bolt 12 is able to push out or dislodge the damaged/stripped fastener from the plurality of engagement features 5.

In reference to FIG. 1-3, the torque-tool body 1 is outwardly extended from a cross section of the plurality of engagement features 5. This yields a socket-like structure with the plurality of engagement features 5 being distributed about the rotational axis 2 on the internal surface of the torque-tool body 1, similar to a wrench socket. Additionally, a wrench handle can be externally and laterally connected to the torque-tool body 1 thus yielding a wrench handle attachment. With respect to both the wrench socket and the wrench handle attachment, each of the plurality of engagement features 5 is extended along a specific length of the torque-tool body 1 thus delineating an empty space within the torque-tool body 1. the aforementioned empty space functions as a receptive cavity for the fastener head so that the plurality of engagement features 5 grip the lateral surface of the fastener head.

A traditional socket wrench design transfers the majority of the torque to the male fastener through the lateral corners of the fastener head. Over time, the degradation of the lateral corners reduces the efficiency of transferring torque from the socket wrench to the fastener head thus causing slippage. The present invention overcomes this problem by moving the torque transfer point to the lateral sides of the fastener head. This is accomplished through the use of the plurality of engagement features 5. Each of the plurality of engagement features 5 is positioned to engage or “bite” the lateral surface of the fastener head instead of the lateral corner. This ensures an adequate amount of torque is transferred to the fastener head to initiate rotation and, resultantly, extraction of the damaged/stripped fastener.

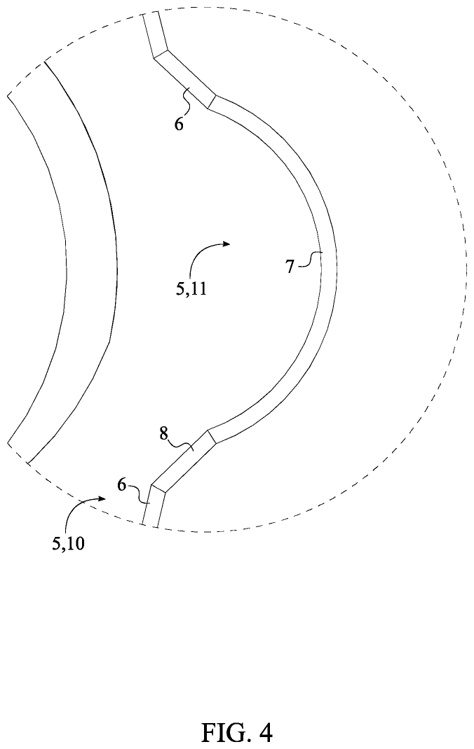

In reference to FIG. 3-4 that illustrates a preferred embodiment of the present invention, a cross section for each of the plurality of engagement features 5 comprises a first slanted section 6, a curved section 7, and a second slanted section 8. More specifically, the first slanted section 6 is terminally connected to the curved section 7. The second slanted section 8 is terminally connected to the curved section 7, wherein the first slanted section 6 and the second slanted section 8 are oppositely positioned of each other about the curved section 7. Resultantly, a gripping edge is delineated in between a pair of engagement features 5 or within one of the engagement feature 5 so that the gripping edge is able to cut into the fastener head during the removal of the damaged/stripped fastener. A top surface 32 of the torque-tool body 1 is positioned in between an outer surface of the base 3 and the plurality of engagement features 5, wherein the top surface 32 is a flat surface. Furthermore, a transition edge between the top surface 32 of the base 3 and the plurality of engagement features 5 is either a chamfered edge or a curved edge that orients towards the threaded opening 4. The first slanted section 6 and the second slanted section 8 are may be collinear or concave to each other so that the first slanted section 6 or the second slanted section 8 becomes an acute angle to the curved section 7.

Furthermore, the plurality of engagement features 5 of the preferred embodiment is equally spaced about the torque-tool body 1 to create an enclosed profile as seen in FIG. 3-4. The length of the first slanted section 6, the curved section 7, and the second slanted section 8 may change. Similarly, corresponding angles between the first slanted section 6, the curved section 7, the second slanted section 8 may vary to create a sharper tooth-like shape. In order to configure the enclosed profile, the plurality of engagement features 5 comprises an arbitrary engagement feature 10 and an adjacent engagement feature 11. The arbitrary engagement feature 10 is any feature within the plurality of engagement features 5 in such a way that the adjacent engagement feature 11 is the feature directly next to the arbitrary engagement feature 10. More specifically, the first slanted section 6 of the arbitrary engagement feature 10 is connected to the second slanted section 8 of the adjacent engagement feature 11 at an obtuse angle. In other words, adjacently positioned first slanted section 6 and the second slanted section 8 are oriented at an obtuse angle thus delineating the profile of the gripping edge. As mentioned above, the present invention may be designed to fit a variety of fastener head designs. This is achieved by varying the number of the plurality of engagement features 5 to compliment different types of fastener head designs. The number of the plurality of engagement features 5 generally corresponds to the number of lateral sides of the fastener head. For example, a pentagon shaped fastener head has five lateral sides. In order to remove the male fastener with the pentagon shaped head, a user has to utilize an embodiment of the present invention that comprises five engagement features as the plurality of engagement features 5. Preferably, the number of the plurality of engagement features 5 in contact with the fastener head can be eighteen, twelve, six, or four.

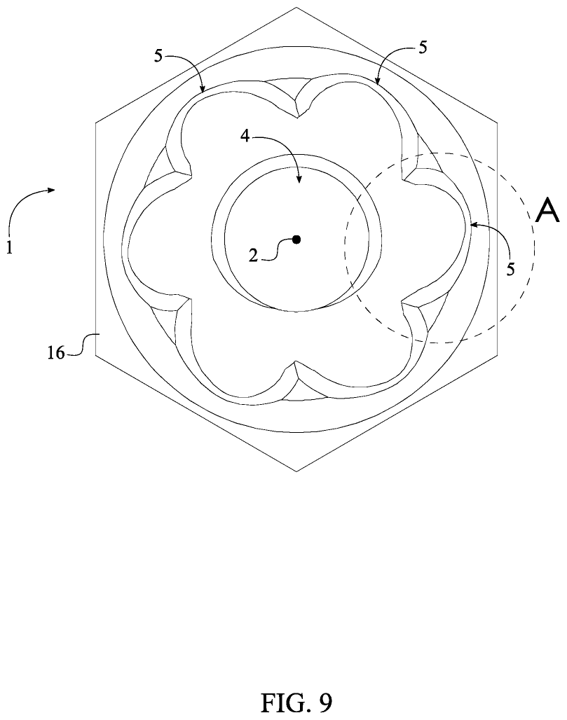

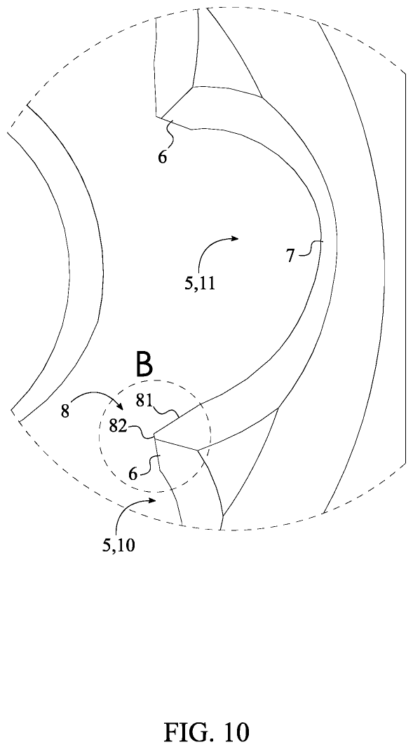

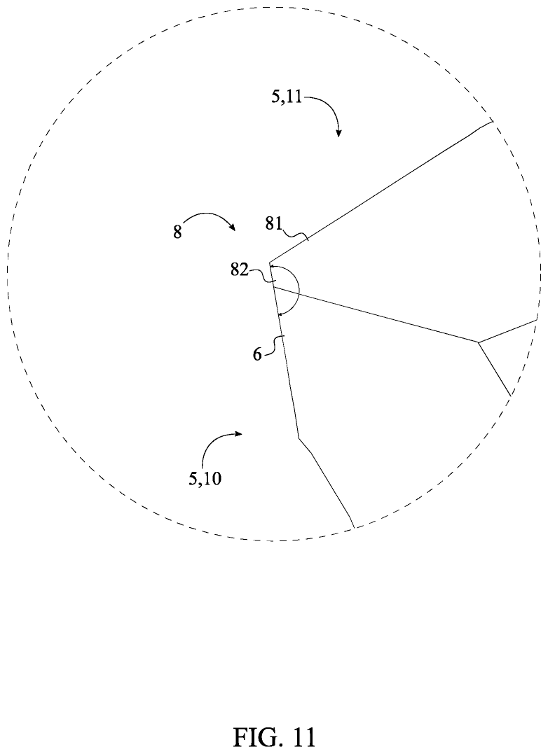

In reference to FIG. 9-11 that illustrates a first alternative embodiment of the present invention, a cross section for each of the plurality of engagement features 5 comprises the first slanted section 6, the curved section 7, and the second slanted section 8. The second slanted section 8 further comprises a proximal section 81 and a distal section 82. More specifically, the first slanted section 6 is terminally connected to the curved section 7. The proximal section 81 of the second slanted section 8 is terminally connected to the curved section 7, wherein the first slanted section 6 and the proximal section 81 of the second slanted section 8 are oppositely positioned of each other about the curved section 7. The distal section 82 of the second slanted section 8 is terminally connected to the proximal section 81 of the second slanted section 8 and positioned opposite of the curved section 7. Resultantly, a gripping edge is delineated in between the proximal section 81 of second slanted section 8 and the distal section 82 of the second slanted section 8 so that the gripping edge is able to cut into the fastener head during the removal of the damaged/stripped fastener. Furthermore, the proximal section 81 of second slanted section 8 and the distal section 82 of the second slanted section 8 are oriented at an obtuse angle thus delineating the profile of the gripping edge.

The plurality of engagement features 5 of the first alternative embodiment is equally spaced about the torque-tool body 1 to create an enclosed profile as seen in FIG. 9-11. The length of the first slanted section 6, the curved section 7, and the second slanted section 8 may change. Similarly, corresponding angles between the first slanted section 6, the curved section 7, and the second slanted section 8 may vary to create a sharper tooth-like shape. In order to configure the enclosed profile, the plurality of engagement features 5 comprises an arbitrary engagement feature 10 and an adjacent engagement feature 11. The arbitrary engagement feature 10 is any feature within the plurality of engagement features 5 in such a way that the adjacent engagement feature 11 is the feature directly next to the arbitrary engagement feature 10. More specifically, the first slanted section 6 of the arbitrary engagement feature 10 is connected to the distal section 82 of the adjacent engagement feature 11 at a straight angle as the distal section 82 and the proximal section 81 are adjacently positioned with each other with an obtuse angle in reference to the adjacent engagement feature 11.

In some embodiment of the first alternative embodiment, an angle between the first slanted section 6 and the distal section 82 is equal to an angle between the distal section 82 and the proximal section 81, wherein the distal section 82 is laterally positioned along the lateral surface of the fastener head. Furthermore, the first slanted section 6, the distal section 82, and the proximal section 81 delineate a trapezoidal shape.

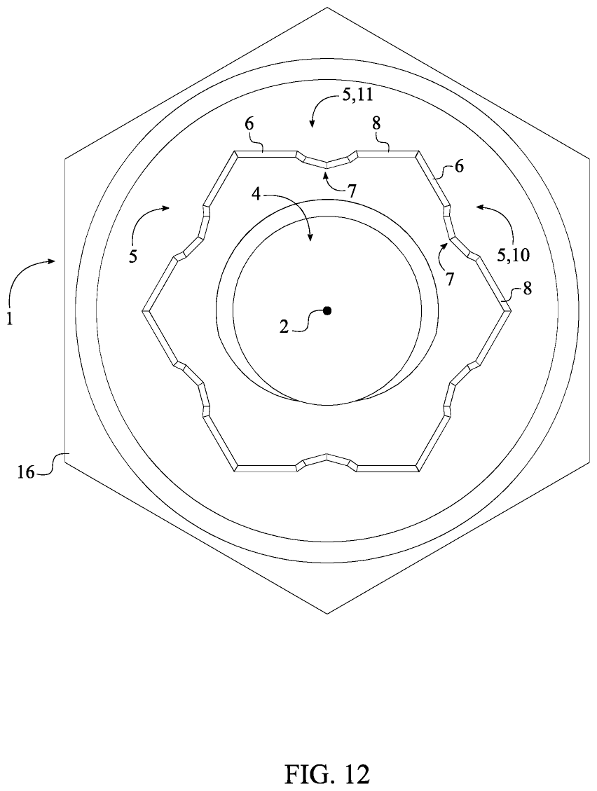

In reference to FIG. 12 that illustrates a second alternative embodiment of the present invention, a cross section for each of the plurality of engagement features 5 comprises the first slanted section 6, the curved section 7, and the second slanted section 8. The curved section 7 further comprises a first section, a second section, a third section, and a fourth section. More specifically, the first section is adjacently connected to the second section. The third section is adjacently connected to the second section and positioned opposite of the first section. The fourth section is adjacently connected to the third section and positioned opposite of the second section. Resultantly, the first slanted section 6 is terminally connected to the first section. The second slanted section 8 is terminally connected to the fourth section, wherein the first slanted section 6 and the second slanted section 8 are oppositely positioned of each other about the curved section 7. Furthermore, first slanted section 6 and the second slanted section 8 are linearly positioned with each other as the curved section 7 oriented towards the rotational axis 2. Resultantly, a gripping edge is delineated within the curved section 7 so that the gripping edge is able to cut into the fastener head during the removal of the damaged/stripped fastener. Furthermore, a first section, a second section, a third section, and a fourth section can be shaped into a plurality of straight sections, a plurality of curved section, or a combination of both the straight and curved sections.

Furthermore, the plurality of engagement features 5 of the second alternative embodiment is equally spaced about the torque-tool body 1 to create an enclosed profile as seen in FIG. 12. The length of the first slanted section 6, the curved section 7, and the second slanted section 8 may change. Similarly, corresponding angles between the first slanted section 6, the curved section 7, the second slanted section 8 may vary to create a sharper tooth-like shape. In order to configure the enclosed profile, the plurality of engagement features 5 comprises an arbitrary engagement feature 10 and an adjacent engagement feature 11. The arbitrary engagement feature 10 is any feature within the plurality of engagement features 5 in such a way that the adjacent engagement feature 11 is the feature directly next to the arbitrary engagement feature 10. More specifically, the first slanted section 6 of the arbitrary engagement feature 10 is connected to the second slanted section 8 of the adjacent engagement feature 11 at an obtuse angle. In other words, adjacently positioned first slanted section 6 and the second slanted section 8 are oriented at an obtuse angle thus delineating the connection point between the pair of engagement features 5 as the gripping edge is profiled within the curved section 7.

Some embodiment of the present invention, the plurality of engagement features 5 can be tapered from the top surface 32 to the threaded opening 4, wherein a diameter of the plurality of engagement features 5 adjacent to the threaded opening 4 is smaller than a diameter of the plurality of engagement features 5 adjacent to the receptive cavity or adjacent to the top surface 32.

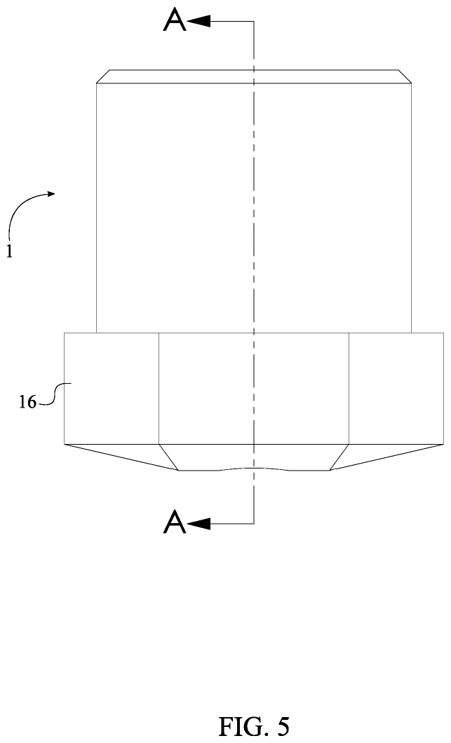

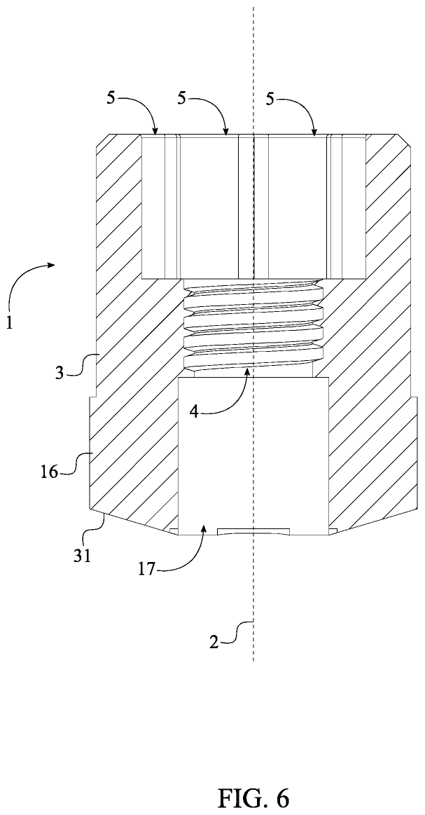

The present invention also incorporates an attachment feature which allows an external torque tool to attach to the torque-tool body 1 and increase the torque force applied to the damaged/stripped fastener. In reference to FIG. 5-6, the present invention further comprises an attachment body 16 and an engagement bore 17 that allow an external tool such as an open ended wrench, a box ended wrench, a combination wrench, an adjustable wrench, and a socket wrench to be attached to the torque-tool body 1. The attachment body 16 is centrally positioned around and along the rotational axis 2 in order to align with the axis of rotation of the torque tool. Furthermore, the attachment body 16 is connected adjacent to the base 3 of the torque-tool body 1 and positioned opposite of the plurality of engagement features 5. The attachment body 16 is preferably of a hexagonal design with a diameter preferably and slightly larger than the diameter for the base 3 of the torque-tool body 1. However, the attachment body 16 may incorporate a smaller diameter than the base 3 depending on the base size and the preferred manufacturing method or design. The engagement bore 17 traverses through the attachment body 16 along the rotational axis 2. The engagement bore 17 is shaped to receive a male attachment member of a socket wrench, wherein the preferred shape of the engagement bore 17 is a square as the majority of socket wrenches utilize a square male attachment member. In alternative embodiments, the shape and design of the engagement bore 17 and the attachment body 16 may vary to be adaptable to different torque tools and different attachment means including, but not limited to, square or cylindrical. In an alternative embodiment, an outer surface of the attachment body 16 may have surface griping treatment applied such as knurling or other alternative methods that would increase the friction between torque-tool body 1 and any driven embodiments.

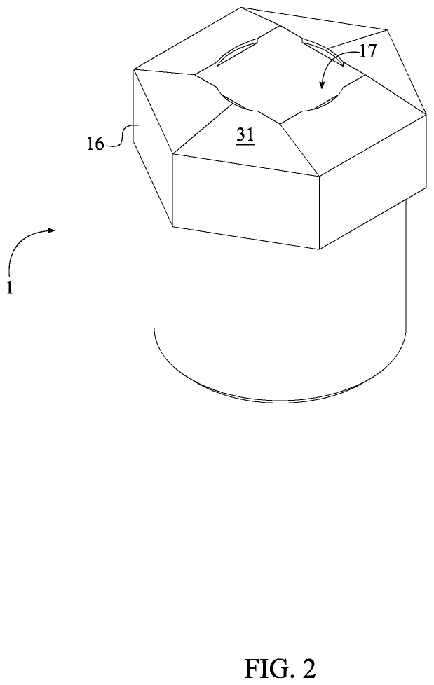

In reference to FIG. 2 and FIG. 6, a bottom surface 31 of the attachment body 16 is tapered away from the engagement bore 17 so that the plurality of engagement features 5 can be driven into the damaged/stripped fasteners by a hammer, without hitting or damaging the engagement bore 17. In other words, a height of the attachment body 16 about the engagement bore 17 is slightly larger than a height of the attachment body 16 about the external surface of the attachment body 16 so that the bottom surface 31 can be tapered away from the engagement bore 17.

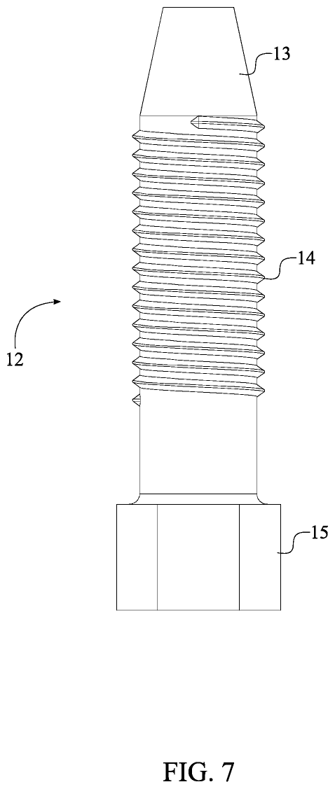

In reference to FIG. 7, the release bolt 12 that dislodges the damaged/stripped fastener comprises a conical tapered section 13, a threaded shaft section 14, and a driver section 15. More specifically, the conical tapered section 13 and the driver section 15 are oppositely positioned of each other about the threaded shaft section 14, wherein the preferred embodiment of the threaded shaft section 14 is a circular body. The conical tapered section 13, threaded shaft section 14, and the driver section 15 are axially positioned with each other so that the conical tapered section 13 is concentrically connected to the threaded shaft section 14 from one end, and the driver section 15 is concentrically connected to the threaded shaft section 14 from the opposite end. Furthermore, a cavity can laterally traverse into the driver section 15 so that a torque applying handle can be engaged within the cavity to apply torque to the release bolt 12 when the release bolt 12 is engaged within the engagement bore 17. The cavity can be any profile including circular, square, or any other geometric profiles.

In reference to facilitate the engagement between the threaded opening 4 and the release bolt 12, the threaded shaft section 14 is designed to match the respective threads of the threaded opening 4. When the damaged/stripped fastener needs to be dislodged, the threaded shaft section 14 is engaged with the threaded opening 4. Resultantly, the conical tapered section 13 is positioned adjacent and within the plurality of engagement features 5, as the driver section 15 is positioned offset of the torque-tool body 1. The user is able to apply the appropriate clockwise or counterclockwise torque to the release bolt 12 via the driver section 15, translating the rotational forces into linear forces until the damaged/stripped fastener is released from the socket. Due to the internal positioning of the conical tapered section 13 within the plurality of engagement features 5, the conical tapered section 13 comes into contact and dislodges the damaged/stripped fastener through the applied linear force. In the preferred embodiment of the driver section 15 is a hexagonal shape. However, in alternative embodiments, shapes of the driver section 15 can include, but is not limited to square, round, or internal drives which may be adapted to a different socket wrench or any other similar tool that can apply rotational force. The conical tapered section 13 may be shaped into cylindrical profile, a square profile, a hexagonal profile, or any other profile preferred by the user or the manufacturer. The threaded shaft section 14 may be any shaped shank including, but not limited to, a semi-round, a semi-square, or any other geometric shaped shank to which a male thread may be applied.

To remove the damaged/stripped fastener with the present invention, the torque-tool body 1 is positioned around the damaged/stripped fastener so that a significant portion of the plurality of engagement features 5 are positioned around the fastener head. The user then simply applies a counter-clockwise torque force to the torque-tool body 1 in order to rotate and remove the damaged/stripped fastener. When a torque force is applied to the torque-tool body 1, the plurality of engagement features 5 “bite” into the lateral sides of fastener head which in turn rotates the fastener. The present invention is designed to engage partially or fully stripped fastener heads. The present invention overcomes slippage of the fastener head through the use of the plurality of engagement features 5 since each of the plurality of engagement features 5 delineates the gripping edge.

Although the invention has been explained in relation to its preferred embodiment, it is to be understood that many other possible modifications and variations can be made without departing from the spirit and scope of the invention as hereinafter claimed.

What is claimed is:

1. A fastener extractor and dislodging tool apparatus comprising:
a torque-tool body;
a threaded opening;
a plurality of engagement features;
a release bolt;
the plurality of engagement features being radially positioned around a rotational axis of the torque-tool body;
the plurality of engagement features being perimetrically connected around a base of the torque-tool body;
the threaded opening traversing through the base; and
the release bolt being threadedly engaged with the threaded opening, opposite of the plurality of engagement features.

2. The fastener extractor and dislodging tool apparatus as claimed in claim 1 comprising:
the torque-tool body being outwardly extended from a cross section of the plurality of engagement features.

3. The fastener extractor and dislodging tool apparatus as claimed in claim 1 comprising:
a cross section for each of the plurality of engagement features comprises a first slanted section, a curved section, and a second slanted section;
the first slanted section being terminally connected to the curved section;
the second slanted section being terminally connected to the curved section; and
the first slanted section and the second slanted section being oppositely positioned of each other about the curved section.

4. The fastener extractor and dislodging tool apparatus as claimed in claim 3 comprising:
the plurality of engagement features comprises an arbitrary engagement feature and an adjacent engagement feature; and
the first slanted section of the arbitrary engagement feature being connected to the second slanted section of the adjacent engagement feature at an obtuse angle.

5. The fastener extractor and dislodging tool apparatus as claimed in claim 1 comprising:
an attachment body;
an engagement bore;
the attachment body being centrally positioned around and along the rotational axis;
the attachment body being adjacently connected to the base of the torque-tool body, opposite of the plurality of engagement features; and
the engagement bore traversing through the attachment body along the rotational axis.

6. The fastener extractor and dislodging tool apparatus as claimed in claim 1 comprising:
the release bolt comprises a conical tapered section, a threaded shaft section, and a driver section;
the conical tapered section and the driver section being oppositely positioned of each other about the threaded shaft section;
the conical tapered section being concentrically connected to the threaded shaft section; and
the driver section being concentrically connected to the threaded shaft section.

7. The fastener extractor and dislodging tool apparatus as claimed in claim 6 comprising:
the threaded shaft section being engaged with the threaded opening;
the conical tapered section being positioned adjacent to the plurality of engagement features; and
the driver section being positioned offset of the torque-tool body.

8. A fastener extractor and dislodging tool apparatus comprising:
a torque-tool body;
a threaded opening;
a plurality of engagement features;
a release bolt;
a cross section for each of the plurality of engagement features comprises a first slanted section, a curved section, and a second slanted section;
the plurality of engagement features being radially positioned around a rotational axis of the torque-tool body;
the plurality of engagement features being perimetrically connected around a base of the torque-tool body;
the first slanted section being terminally connected to the curved section;
the second slanted section being terminally connected to the curved section;
the first slanted section and the second slanted section being oppositely positioned of each other about the curved section;
the threaded opening traversing through the base; and
the release bolt being threadedly engaged with the threaded opening, opposite of the plurality of engagement features.

9. The fastener extractor and dislodging tool apparatus as claimed in claim 8 comprising:
the torque-tool body being outwardly extended from a cross section of the plurality of engagement features.

10. The fastener extractor and dislodging tool apparatus as claimed in claim 8 comprising:
the plurality of engagement features comprises an arbitrary engagement feature and an adjacent engagement feature; and
the first slanted section of the arbitrary engagement feature being connected to the second slanted section of the adjacent engagement feature at an obtuse angle.

11. The fastener extractor and dislodging tool apparatus as claimed in claim 8 comprising:
an attachment body;
an engagement bore;
the attachment body being centrally positioned around and along the rotational axis;
the attachment body being adjacently connected to the base of the torque-tool body, opposite of the plurality of engagement features; and
the engagement bore traversing through the attachment body along the rotational axis.

12. The fastener extractor and dislodging tool apparatus as claimed in claim 8 comprising:
the release bolt comprises a conical tapered section, a threaded shaft section, and a driver section;
the conical tapered section and the driver section being oppositely positioned of each other about the threaded shaft section;
the conical tapered section being concentrically connected to the threaded shaft section; and
the driver section being concentrically connected to the threaded shaft section.

13. The fastener extractor and dislodging tool apparatus as claimed in claim 12 comprising:
the threaded shaft section being engaged with the threaded opening;
the conical tapered section being positioned adjacent to the plurality of engagement features; and
the driver section being positioned offset of the torque-tool body.

14. A fastener extractor and dislodging tool apparatus comprising:
a torque-tool body;
a threaded opening;
a plurality of engagement features;
a release bolt;
a cross section for each of the plurality of engagement features comprises a first slanted section, a curved section, and a second slanted section;
the release bolt comprises a conical tapered section, a threaded shaft section, and a driver section;
the plurality of engagement features being radially positioned around a rotational axis of the torque-tool body;
the plurality of engagement features being perimetrically connected around a base of the torque-tool body;
the first slanted section being terminally connected to the curved section;
the second slanted section being terminally connected to the curved section;
the first slanted section and the second slanted section being oppositely positioned of each other about the curved section;
the threaded opening traversing through the base;
the release bolt being threadedly engaged with the threaded opening, opposite of the plurality of engagement features;
the threaded shaft section being engaged with the threaded opening;
the conical tapered section being positioned adjacent to the plurality of engagement features; and
the driver section being positioned offset of the torque-tool body.

15. The fastener extractor and dislodging tool apparatus as claimed in claim 14 comprising:
the torque-tool body being outwardly extended from a cross section of the plurality of engagement features.

16. The fastener extractor and dislodging tool apparatus as claimed in claim 14 comprising:
the plurality of engagement features comprises an arbitrary engagement feature and an adjacent engagement feature; and
the first slanted section of the arbitrary engagement feature being connected to the second slanted section of the adjacent engagement feature at an obtuse angle.

17. The fastener extractor and dislodging tool apparatus as claimed in claim 14 comprising:
an attachment body;
an engagement bore;
the attachment body being centrally positioned around and along the rotational axis;
the attachment body being adjacently connected to the base of the torque-tool body, opposite of the plurality of engagement features; and
the engagement bore traversing through the attachment body along the rotational axis.

18. The fastener extractor and dislodging tool apparatus as claimed in claim 14 comprising:
the conical tapered section and the driver section being oppositely positioned of each other about the threaded shaft section;
the conical tapered section being concentrically connected to the threaded shaft section; and
the driver section being concentrically connected to the threaded shaft section.
